(19) United States
(12) Patent Application Publication
(10) Pub. No.: US 2011/0254272 A1
(43) Pub. Date: Oct. 20, 2011

(54) CYCLOID REDUCTION GEAR FOR WIND FORCE GENERATOR

(75) Inventor: Hyeon-Guk LEE, Bucheon-Si (KR)

(73) Assignee: HAISUNG INDUSTRIAL SYSTEMS CO., LTD., Incheon (KR)

(21) Appl. No.: 12/784,195

(22) Filed: May 20, 2010

(30) Foreign Application Priority Data
Apr. 19, 2010 (KR) 10-2010-0036059

(51) Int. Cl. H02P 9/04

(52) U.S. Cl. 290/44

(57) ABSTRACT

A cycloid reduction gear for a wind force generator is provided. The wind force generator having generation blades and horizontal and vertical axes includes: a horizontal-axis reduction gear provided in a direction perpendicular to the vertical axis to rotate the generation blades in a horizontal direction; and a horizontal-axis rotation ring gear installed at the vertical axis and internally contacting with the horizontal axis reduction gear to rotate the vertical axis in a horizontal direction according to a rotation of the horizontal axis reduction gear. Thereby, the horizontal axis of the wind force generator can rotate according to a wind direction, and by combining and installing a reduction gear and a cycloid disk in the wind force generator, the horizontal axis moves in an appropriate reduced ratio and thus the wind force generator can stably operate according to a wind direction.

### BACKGROUND OF THE INVENTION

1. Field of the Invention

The present invention relates to a cycloid reduction gear for a wind force generator, and more particularly, to a cycloid reduction gear for a wind force generator that can stably rotate the wind force generator in a predetermined reduced speed when a horizontal axis of the wind force generator horizontally rotates in a predetermined angle.

2. Description of the Related Art

In general, in a wind force generator, axes are classified into a horizontal axis and a vertical axis according to a position of a rotation axis of blades, and the wind force generator rotates blades with natural wind, rotates using a gear with the rotating blades, is a pollution free energy source of a natural state, and has been spotlighted as an alternative energy source having greatest economical efficiency among alternative energy sources for substituting a fossil fuel.

However, unlike climate environment of foreign countries, in climate environment of the Republic of Korea, a wind direction frequently changes and in an upper part and a lower part of space in which a wind blows, wind directions are different and intensity of a wind is weak and thus a wind force generator for using in the Republic of Korea has been improved to enhance generation efficiency by a wind force.

For example, a conventional vertical axis wind force generator is provided to rotate wind blades vertically stacked at space of an upper part and a lower part in which a wind blows by stacking and fixing the wind blades along a vertical axis.

However, unlike climate environment of foreign countries, in climate environment of the Republic of Korea, a wind direction frequently changes and in an upper part and a lower part of space in which a wind blows, wind directions are different and intensity of a wind is weak.

Thereby, when directions of a wind transferred to wind blades installed in an upper part of a vertical axis and wind blades installed in a lower part of the vertical axis among wind blades stacked along the vertical axis are different, because the wind blades are fixed to the vertical axis, a problem that a rotation of the wind blades is reduced exists.

### SUMMARY OF THE INVENTION

The present invention has been made in view of the above problems, and provides a cycloid reduction gear for a wind force generator that can stably operate the wind force generator according to a wind direction by enabling a horizontal axis to move in an appropriate reduced ratio by combining and installing a reduction gear and a cycloid disk in the wind force generator when a horizontal axis of the wind force generator rotates according to a wind direction.

In accordance with an aspect of the present invention, a wind force generator including a wind force generation vertical axis 100, a wind force generation horizontal axis 200, and wind force generation blades 300 includes: a horizontal axis reduction gear 400 in which at least two are provided in a direction perpendicular to the wind force generation vertical axis 100 to rotate the wind force generation blades 300 in a horizontal direction; and a horizontal axis rotation ring gear 500 installed at the wind force generation vertical axis 100 and internally contacting with the horizontal axis reduction gear 400 to rotate the wind force generation vertical axis 100 in a horizontal direction according to a rotation of the horizontal axis reduction gear 400.

Preferably, the horizontal axis reduction gear 400 includes: a driving motor 1 for receiving electricity from the outside and for rotating with a predetermined speed and for rotating a rotation axis protruded at a front surface thereof; a power transmission gear 10 coupled to the rotation axis of the driving motor 1 and having gear teeth at the outer circumference edge thereof; a spur gear 20 coupled to the power transmission gear 10 and having gear teeth of the quantity more than those of the power transmission gear 10 at the outer circumference edge thereof and for firstly reducing a driving speed of the driving motor 1 while rotating with engaged with the power transmission gear 10; a shaft 30 shaft-coupled to the center of the spur gear 20 and having a multistage eccentric cam in a body thereof and for rotating according to a rotation of the spur gear 20; a cycloid disk 40 for coupling the shaft 30 at the inside thereof by forming a coupling hole at the inside thereof and forming gear teeth at the outside thereof and for rotating with a rotation speed lower than that of the eccentric cam by a rotation of the eccentric cam; a ring gear 50 coupled to an outer gear of the cycloid disk 40 and having the gear quantity more than that of the cycloid disk 40 and for secondly reducing a driving speed of the driving motor 1 by reducing a rotation speed of the shaft 30 of the reduction gear when the cycloid disk 40 rotates along the ring gear 50; a planetary gear including a sun gear 61 coupled to the cycloid disk 40 to rotate with the same speed according to a rotation of the cycloid disk 40, an idle gear 62 coupled to the outside of the sun gear 61 to perform a rotation movement and a revolution movement, a ring gear 63 installed at the outside of the idle gear 62 to rotate the idle gear 62, and a power transmission pin 64 installed at a central axis of the idle gear 62 to rotate with a revolution speed of the idle gear 62 and for thirdly reducing a driving speed of the driving motor 1; a clipper 70 coupled to a power transmission pin 64 to transfer the rotary power of the power transmission pin 64; and a pinion gear 3 coupled to an end portion of an output shaft for rotating according to a rotation of the clipper 70 by coupling the clipper 70 to the outer circumferential edge thereof and for rotating to correspond to a speed of the output shaft and for enabling an upper rotation body to rotate about a lower traveling body while rotating with engaged with a gear of the lower traveling body.

### BRIEF DESCRIPTION OF THE DRAWINGS

The objects, features and advantages of the present invention will be more apparent from the following detailed description in conjunction with the accompanying drawings, in which:

FIG. 1 is a perspective view illustrating a wind power generator for applying a reduction gear according to an exemplary embodiment of the present invention;

FIG. 2 is a perspective view illustrating a configuration of the wind power generator of FIG. 1;

FIG. 3 is a perspective view illustrating a configuration of a reduction gear for applying to the wind power generator of FIG. 1; and

FIG. 4 is a cross-sectional view of the reduction gear of FIG. 3.

### DETAILED DESCRIPTION OF EXEMPLARY EMBODIMENTS

Hereinafter, exemplary embodiments of the present invention are described in detail with reference to the accompanying drawings. The same reference numbers are used throughout the drawings to refer to the same or like parts. The views in the drawings are schematic views only, and are not intended to be to scale or correctly proportioned. Detailed descriptions of well-known functions and structures incorporated herein may be omitted to avoid obscuring the subject matter of the present invention.

While the present invention may be embodied in many different forms, specific embodiments of the present invention are shown in drawings and are described herein in detail, with the understanding that the present disclosure is to be considered as an exemplification of the principles of the invention and is not intended to limit the invention to the specific embodiments illustrated.

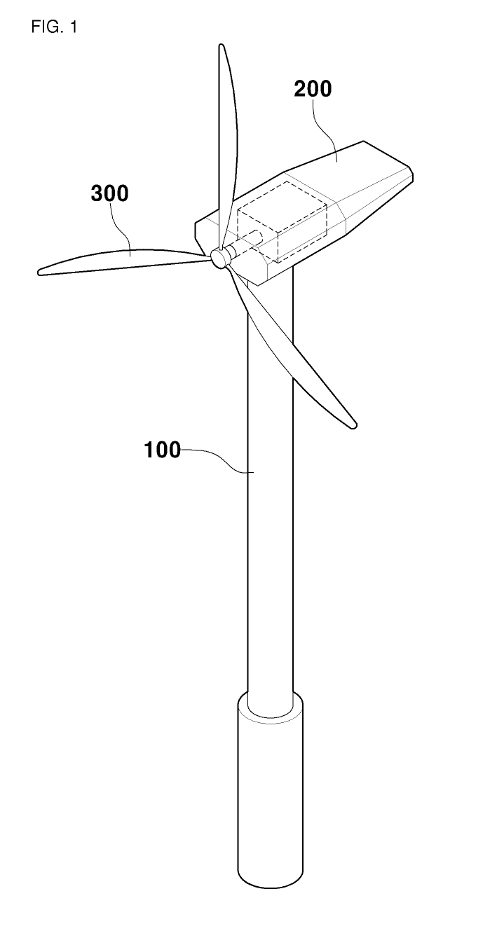

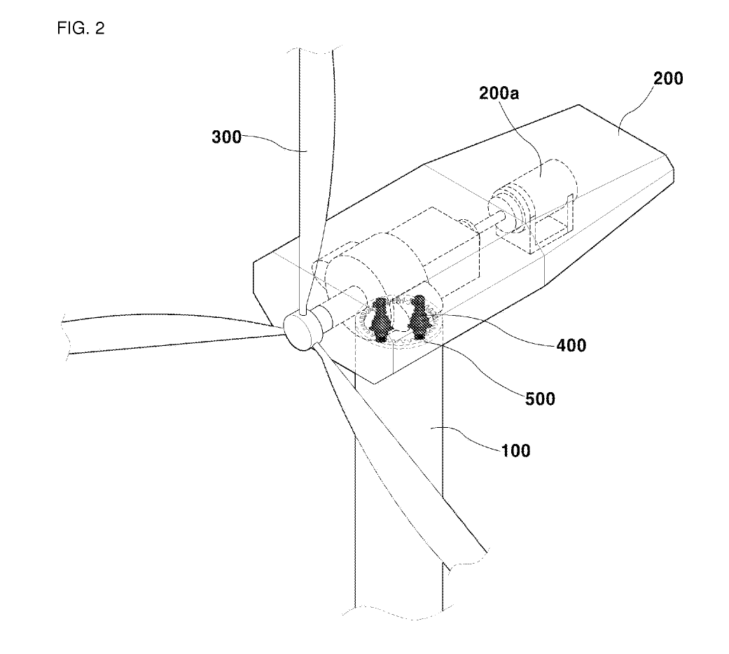

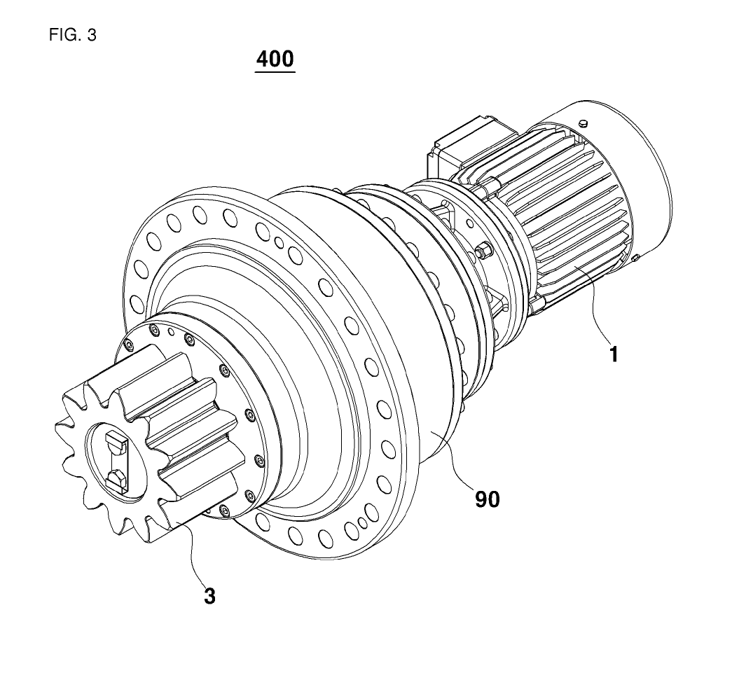

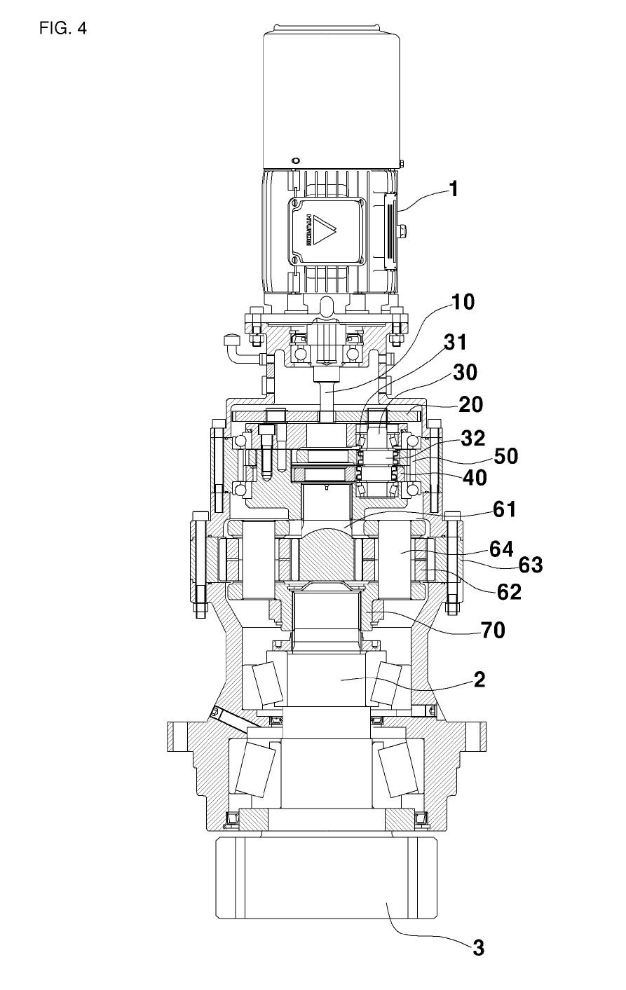

FIG. 1 is a perspective view illustrating a wind power generator for applying a reduction gear according to an exemplary embodiment of the present invention, FIG. 2 is a perspective view illustrating a configuration of the wind power generator of FIG. 1, FIG. 3 is a perspective view illustrating a configuration of a reduction gear for applying to the wind power generator of FIG. 1, and FIG. 4 is a cross-sectional view of the reduction gear of FIG. 3.

A wind power generator according to an exemplary embodiment of the present invention includes a wind force generation vertical axis 100, a wind force generation horizontal axis 200, a wind force generation blade 300, a horizontal axis reduction gear 400 in which at least two are provided in a direction perpendicular to the wind force generation vertical axis 100 to rotate the wind force generation blade 300 in a horizontal direction, and a horizontal axis rotation ring gear 500 installed at the wind force generation vertical axis 100 and internally contacting with the horizontal axis reduction gear 400 to rotate the wind force generation horizontal axis 200 in a horizontal direction according to a rotation of the horizontal axis reduction gear 400.

A configuration of the horizontal axis reduction gear 400 is described in detail.

The horizontal axis reduction gear 400 includes a driving motor 1, power transmission gear 10, spur gear 20, shaft 30, cycloid disk 40, ring gear 50, planetary gear in which a sun gear 61, idle gear 62, ring gear 63, and power transmission pin 64 are coupled, clipper 70, and pinion gear 3.

The driving motor 1 receives electricity from the outside to rotate with a predetermined speed and rotates a rotation axis protruded at a front surface thereof.

The power transmission gear 10 is coupled to a rotation axis of the driving motor 1 and has gear teeth at the outer circumferential edge thereof. That is, because the power transmission gear 10 is shaft-coupled to the driving motor 1, the power transmission gear 10 rotates with the same rotation speed as that of the driving motor 1.

The spur gear 20 is coupled to the power transmission gear 10 and has gear teeth of the quantity more than the power transmission gear 10 at the outer circumferential edge thereof and firstly reduces a driving speed of the driving motor 1 while rotating with engaged with the power transmission gear 10.

The shaft 30 is shaft-coupled to the center of the spur gear 20, has a multistage eccentric cam 32 in a body thereof, and rotates according to a rotation of the spur gear 20.

The cycloid disk 40 has a coupling hole at the inside thereof and has gear teeth at the outside thereof and thus couples the shaft 30 through bearings 31, and rotates with a rotation speed lower than that of an eccentric cam 32 with a rotation function of the eccentric cam 32. In this case, the shaft 30 performs a revolution movement according to a rotation of the cycloid disk 40 and simultaneously performs a rotation movement and a revolution movement.

When the eccentric cam 32 rotates by 360° with a rotation of the shaft 30, the cycloid disk 40 backlashes by 1 gear pitch while being engaged with the ring gear 50.

An outer gear of the cycloid disk 40 is coupled to the ring gear 50, and the ring gear 50 has the gear quantity more than that of the cycloid disk 40, and when the cycloid disk 40 rotates along the ring gear 50, the ring gear 50 secondly reduces a driving speed of the driving motor 1 by reducing a rotation speed of the shaft 30. That is, because the quantity of the ring gear 50 is formed more than that of the cycloid disk 40, when the gear of the cycloid disk 40 engages with the ring gear 50, the gear of the cycloid disk 40 engages with the ring gear 50 with the fewer quantity by one gear tooth and thus the cycloid disk 40 reduces a speed in a pitch ratio while reversely rotating in the ring gear 50.

That is, when the eccentric cam 32 rotates by 360° with a rotation of the shaft 30, the cycloid disk 40 rotates, and in this case, when the gear of the cycloid disk 40 sequentially engages with the ring gear 50, if the gear of the cycloid disk 40 has the difference of 1 gear quantity, the gear of the cycloid disk 40 backlashes by 1 gear pitch.

The planetary gear includes a sun gear 61 coupled to the cycloid disk 40 to rotate with the same speed according to a rotation of the cycloid disk 40, an idle gear 62 coupled to the outside of the sun gear 61 to perform a rotation movement and a revolution movement, a ring gear 63 installed at the outside of the idle gear 62 to rotate the idle gear 62, and a power transmission pin 64 installed at a central axis of the idle gear 62 to rotate with a revolution speed of the idle gear 62 and thirdly reduce a driving speed of the driving motor 1.

The clipper 70 is coupled to the outer circumferential edge of the power transmission pin 64 of the planetary gear to transfer the rotary power of the power transmission pin 64.

The pinion gear 3 is coupled to an end portion of an output shaft 2 for rotating according to a rotation of the clipper 70 by coupling the clipper 70 to the outer circumferential edge thereof and rotates to correspond to a speed of the output shaft 2 and enables an upper rotation body to rotate about a lower traveling body while rotating with engaged with a gear of the lower traveling body.

Hereinafter, operation of the present invention is described.

First, in a case of rotating the wind force generation horizontal axis 200, when the horizontal axis reduction gear 400 is driven, the horizontal axis reduction gear 400 rotates and thus the horizontal axis rotation ring gear 500 rotates, whereby the wind force generation horizontal axis 200 rotates in a predetermined angle.

That is, the horizontal axis reduction gear 400 internally contacts with the horizontal axis rotation ring gear 500 and is installed in plural and thus rotates by a desired angle while rotating the horizontal axis rotation ring gear 500 with a reduced speed.

Hereinafter, operation of the horizontal axis reduction gear 400 is described in detail.

When an electrical signal is applied to the driving motor 1, the driving motor 1 rotates with a predetermined speed.

When the driving motor 1 rotates, the power transmission gear 10 coupled to a rotation axis rotates, and the power transmission gear 10 rotates with the same rotation speed as that of the driving motor 1.

When the power transmission gear 10 rotates, the spur gear 20 coupled to the outer circumferential edge thereof rotates and in this case, as the spur gear 20 has gear teeth more than those of the power transmission gear 10, the spur gear 20 firstly reduces a driving speed of the driving motor 1 while rotating with engaged with the power transmission gear 10.

That is, because the gear quantity of the spur gear 20 is more than that of the power transmission gear 10, the spur gear 20 rotates with a reduced speed by the gear quantity of the power transmission gear/the gear quantity of the spur gear.

That is, if the gear quantity of the power transmission gear 10 is 10 and the gear quantity of the spur gear 20 is 40, the spur gear 20 rotates with reduced to a speed of 1/4 and thus the driving motor 1 rotates in a reduced speed with a reduced ratio of 1/4.

Thereafter, when the spur gear 20 rotates, the shaft 30 coupled to a central axis of the spur gear 20 rotates, and the shaft 30 rotates with the same rotation speed as that of the spur gear 20.

A multistage eccentric cam 32 is formed in a body of the shaft 30, and the body is inserted into and coupled to a coupling hole within the cycloid disk 40 through bearings 31 and rotates.

In this case, because one side of the gear of the cycloid disk 40 engages with the ring gear 50, when the shaft 30 rotates, the cycloid disk 40 rotates while being engaged with the ring gear 50, and because the gear quantity of the ring gear 50 is more than that of the cycloid disk 40, a speed of the ring gear 50 is reduced to a ratio of (the gear quantity of the ring gear−the gear quantity of the cycloid disk)/the gear quantity of the cycloid disk.

That is, if the gear quantity of the cycloid disk 40 is 12 and the gear quantity of the ring gear 90 is 13, the speed of the ring gear is reduced to a ratio of 1/12.

When the cycloid disk 40 rotates along the ring gear 50, a rotation speed of the shaft 30 is reduced and thus a driving speed of the driving motor 1 is secondary reduced.

Thereafter, when the cycloid disk 40 rotates, the sun gear 61 coupled to the cycloid disk 40 rotates, and when the sun gear 61 rotates, the idle gear 62 coupled to the outside thereof rotates and the idle gear 62 rotates while being engaged with the ring gear 50.

In this case, the idle gear 62 rotates and revolves and reduces a speed of the cycloid disk 40 by a revolution speed and thus a driving speed of the driving motor 1 is thirdly reduced.

Because the powering transmission pin 64 is coupled to the idle gear 62, the powering transmission pin 64 rotates to correspond to the revolution speed of the idle gear 62, and because the clipper 70 is coupled to the powering transmission pin 64, the clipper 70 rotates with a rotation speed corresponding to that of the powering transmission pin 64.

The output shaft 2 is coupled to the clipper 70 to rotate with the same rotation speed as that of the clipper 70, and the pinion gear 3 is coupled to the output shaft 2 to rotate with the same rotation speed as that of the output shaft 2 and thus the wind force generation horizontal axis or the wind force generation blade slowly rotates with a thirdly reduced speed, compared with a driving speed of the driving motor 1.

As described above, according to the present invention, the horizontal axis of the wind force generator can rotate according to a wind direction, and by combining and installing a reduction gear and a cycloid disk in the wind force generator, the horizontal axis moves in an appropriate reduced ratio and thus the wind force generator can stably operate according to a wind direction.

Although exemplary embodiments of the present invention have been described in detail hereinabove, it should be clearly understood that many variations and modifications of the basic inventive concepts herein described, which may appear to those skilled in the art, will still fall within the spirit and scope of the exemplary embodiments of the present invention as defined in the appended claims.

What is claimed is:

1. A wind force generator comprising a wind force generation vertical axis, a wind force generation horizontal axis, and wind force generation blades, comprising:
a horizontal axis reduction gear in which at least two are provided in a direction perpendicular to the wind force generation vertical axis to rotate the wind force generation blades in a horizontal direction; and
a horizontal axis rotation ring gear installed at the wind force generation vertical axis and internally contacting with the horizontal axis reduction gear to rotate the wind force generation vertical axis in a horizontal direction according to a rotation of the horizontal axis reduction gear.

2. The wind force generator of claim 1, wherein the horizontal axis reduction gear comprises:
a driving motor 1 for receiving electricity from the outside and for rotating with a predetermined speed and for rotating a rotation axis protruded at a front surface thereof;
a power transmission gear coupled to the rotation axis of the driving motor and having gear teeth at the outer circumference edge thereof;
a spur gear coupled to the power transmission gear and having gear teeth of the quantity more than those of the power transmission gear at the outer circumference edge thereof and for firstly reducing a driving speed of the driving motor while rotating with engaged with the power transmission gear;
a shaft shaft-coupled to the center of the spur gear and having a multistage eccentric cam in a body thereof and for rotating according to a rotation of the spur gear;
a cycloid disk for coupling the shaft at the inside thereof by forming a coupling hole at the inside thereof and forming gear teeth at the outside thereof and for rotating with a rotation speed lower than that of the eccentric cam by a rotation of the eccentric cam;
a ring gear coupled to an outer gear of the cycloid disk and having the gear quantity more than that of the cycloid disk and for secondly reducing a driving speed of the driving motor by reducing a rotation speed of the shaft of the reduction gear when the cycloid disk rotates along the ring gear;
a planetary gear comprising a sun gear coupled to the cycloid disk to rotate with the same speed according to a rotation of the cycloid disk, an idle gear coupled to the outside of the sun gear to perform a rotation movement and a revolution movement, a ring gear installed at the outside of the idle gear to rotate the idle gear, and a power transmission pin installed at a central axis of the idle gear to rotate with a revolution speed of the idle gear and for thirdly reducing a driving speed of the driving motor;
a clipper coupled to a power transmission pin to transfer the rotary power of the power transmission pin; and
a pinion gear coupled to an end portion of an output shaft for rotating according to a rotation of the clipper by coupling the clipper to the outer circumferential edge thereof and for rotating to correspond to a speed of the output shaft and for enabling an upper rotation body to rotate about a lower traveling body while rotating with engaged with a gear of the lower traveling body.
